(19) United States
(12) Patent Application Publication
(10) Pub. No.: US 2026/0225108 A1
(43) Pub. Date: Aug. 6, 2026

(54) POWER SPLITTING FOR A COMMINUTING DEVICE

(71) Applicant: Manuel LINDNER, Spittal/Drau (AT)

(72) Inventors: Manuel LINDNER, Spittal/Drau (AT); Peter SCHIFFER, Spittal/Drau (AT)

(73) Assignee: Manuel LINDNER, Spittal/Drau (AT)

(21) Appl. No.: 19/153,230

(22) PCT Filed: Nov. 6, 2023
(86) PCT No.: PCT/EP2023/080793

§ 371 Date: Aug. 1, 2025

(30) Foreign Application Priority Data
Feb. 3, 2023 (EP) 23154933.8

(51) Int. Cl. B02C 18/24

(52) U.S. Cl. CPC B02C 18/24

(57) ABSTRACT

The present invention relates to a device for driving a rotor shaft of a comminuting device. This device comprises a first motor, a hydraulic gearing and a synchromesh gearing, which is different from the hydraulic gearing and is designed to drive at least one rotor shaft or at least one drive shaft connected to a rotor shaft. The first motor and the hydraulic gearing are connected to the synchromesh gearing.

### FIELD OF THE INVENTION

The present invention relates to a device with a power splitting for driving a rotor shaft of a comminuting device for comminuting material, in particular in the form of waste products. The present invention further relates to a comminuting device with such a device.

### PRIOR ART

Commercial waste, industrial waste, household waste, etc., such as (hard) plastics, textiles, composites, rubber, or waste wood (such as pallets and chipboard), must be comminuted before final disposal or, in particular, before being returned to the recycling cycle. Single or multi-shaft shredders are typically used for comminution, which are fed by wheel loaders, forklifts, or conveyor belts via a hopper for material feeding. The comminution of the fed material takes place between knives rotating with a rotor shaft (comminution shaft) and stationary, i.e. non-rotating, counter knives (stator knives, scraper combs).

The rotor shaft is typically driven by a drive shaft connected to it via a shaft coupling. The drive shaft is driven by a motor via a gearing. Hydraulic gearings with controllable hydraulic pumps and controllable hydraulic motors are often used. Such hydraulic gearings offer the advantage of being able to increase the drive torque in response to load requirements by reducing the speed and increasing the hydraulic pressure. By increasing the drive torque, it is possible to largely prevent the rotor shafts from blocking or reversing and thus interrupting the comminution, i.e., a loss in throughput, and the risk that the reverse rotation of the shafts will result in a poorer comminution result, which negatively affects the overall result with regard to the desired granulate size.

However, due to system-related factors, the known solutions of the prior art exhibit high power losses (>30%) under changing loads, as they occur in everyday operation.

Furthermore, configurations with power-split gearings are known, in which a direct drive interacts with a hydraulic gearing integrated into a planetary gearing. However, such power-split gearings are complex in construction and are maintenance- and cost-intensive.

In view of the above problems, it is therefore one of the underlying problems of the present invention to provide a simplified device for driving a rotor shaft of a comminuting device, which can generate the maximum necessary torques with low power loss and low structural complexity and transmit them to the rotor shaft.

### DESCRIPTION

The above problem is solved by a device (with power splitting) for driving (at least) one rotor shaft (comminuting shaft) of a comminuting device according to claim 1. This device comprises a first motor, a hydraulic gearing (hydrostatic gearing) and a synchronous gearing (synchronized gearing) which is different from the hydraulic gearing and is configured to drive at least one rotor shaft or at least one drive shaft connected to a rotor shaft. The first motor and the hydraulic gearing are connected to the synchronous gearing.

Here and in the following, it is understood that when a component is connected to another, this connection may be a direct connection or a connection via another component. All operating parameters of the components of the device can be regulated/controlled (closed-loop controlled/open-loop controlled) by a central regulation/control unit.

This device allows for an overall energy-efficient provision of torque for one or more shafts of a comminuting device, wherein a direct drive is provided by means of the first motor with high energy efficiency (part of a first power split) with the advantages of a hydraulic gearing (part of a second power split) for increasing the torque provided when the load on the one or more shafts increases, without the need for complicated, specially adapted power-split gearings. The torque provided by the motor can be combined with the torque provided by the hydraulic gearing in a cost-effective manner by means of a relatively simple synchronous gearing and transmitted to one or more shafts. If only a relatively small or medium load is applied to one or more shafts, i.e., if only a relatively small or medium torque is required, this torque can be supplied by the first motor alone, for example, and if the load increases, for example, if a load threshold value is exceeded, the hydraulic gearing can be switched in to supply additional torque.

The device may further comprise a first reduction gearing different from the hydraulic gearing and/or a second reduction gearing different from the first reduction gearing and the hydraulic gearing. In this case, the first motor is connected to the first reduction gearing and/or the hydraulic gearing is connected to the second reduction gearing, and the first and/or second reduction gearing are connected to the synchronous gearing. The first and second reduction gearings serve to adapt the speed supplied by the first motor and the hydraulic gearing to the speed required for one or more shafts (drive shafts and rotor shafts) and may be formed in a single unit.

The device may further comprise a direct drive and/or a coupling via which the first motor is connected to the synchronous gearing. If the first synchronous gearing is provided, the first motor may be connected to this first synchronous gearing via the direct drive and/or the coupling. In particular, the coupling may be arranged between the direct drive and the first reduction gearing and may be configured as an overload coupling which, in particular in the event of a sudden total blockage of a rotor shaft of a comminuting device comprising the device, decouples the motor/direct drive. The coupling can be a switchable coupling in order to decouple the first motor/direct drive in the event that the rotor shaft needs to be reversed by means of the switchable coupling. The direct drive can be a belt drive, for example. Alternatively, the first motor can be connected to the first reduction gearing via a joint shaft. Alternatively, the first motor can be connected directly to the first reduction gearing or mounted on the reduction gearing. If the first motor provides the speed required by the shaft to be driven, it can be connected directly to the synchronous gearing without a reduction gearing.

According to further embodiment, the first motor is an electric motor. Electric motors are characterized by high energy efficiency and zero CO₂ emissions. Alternatively, the first motor can be configured as a combustion engine (e.g., a diesel engine), for example, for applications where no suitable power grid is available.

Furthermore, the device may comprise a first frequency converter which is configured to regulate or control the speed and/or the direction of rotation of the first electric motor so that the operation of the motor can be adapted to changing operating conditions (e.g., full load or reversing shafts) in a simple and quick manner.

According to a further embodiment, the first motor of the device is connected to the hydraulic gearing in order to operate it. The hydraulic gearing can thus comprise a hydraulic pump operable by the first motor and a hydraulic motor connected to the hydraulic pump, which is connected to the synchronous gearing via the second reduction gearing, if necessary. Alternatively, the device may comprise a second motor, which is different from the first motor and is connected to the hydraulic gearing. This second motor can operate exclusively a hydraulic pump in the hydraulic gearing to supply a hydraulic motor in the gearing with hydraulic fluid. The second motor may also be configured as an electric motor. In this case, the device may include a second frequency converter configured to regulate the speed and/or direction of rotation of the electric motor.

Furthermore, a comminuting device is provided, comprising a material receiving space, a rotor shaft arranged therein, and a device according to one of the preceding claims. The rotor shaft is connected to the synchronous gearing of the device via a drive shaft and a shaft coupling in order to drive the rotor shaft. The comminuting device may in particular be a large and heavy device for comminuting wood, plastic or textile waste products as well as other industrial, agricultural and household waste weighing several tons. It may be a single-shaft or multi-shaft comminutor, in particular a vertical comminutor.

Furthermore, a method for operating a device according to one of the examples described above or a comminuting device according to one of the examples described above is provided, comprising the following steps carried out in succession in the order listed:
operating the first motor to transmit torque via the first reduction gearing, if provided, and the synchronous gearing to at least one shaft connected to the synchronous gearing in a first operating state at a first load of the at least one shaft without transmitting torque from the hydraulic gearing to the at least one shaft,
additionally operating the hydraulic gearing for transmitting torque via the second reduction gearing, if provided, and the synchronous gearing to the at least one shaft in a second operating state at a second load of the at least one shaft which is greater than the first load; and
operating the hydraulic gearing for transmitting a torque increased relative to the second operating state via the second reduction gearing, if provided, and the synchronous gearing to the at least one shaft in a third operating state at a third load of the at least one shaft, which is greater than the second load.

The method may further comprise, in a fourth operating state following the third operating state, the step of operating the hydraulic gearing with an increased displacement of a hydraulic motor of the hydraulic gearing relative to the third operating state and adjusting the speed of the first motor to the speed of the hydraulic motor of the hydraulic gearing.

These methods allow the comminution process of a material to be comminuted to be regulated or controlled in a highly variable and fine manner in accordance with the load acting on the rotor shaft (shafts), i.e. in accordance with the total torque required for comminuting a material to be comminuted.

Further features and exemplary embodiments of the present invention are explained in more detail below with reference to the drawing. It should be understood that the embodiments do not exhaust the scope of the present invention. It should also be understood that some or all of the features described below may also be combined with each other in other ways.

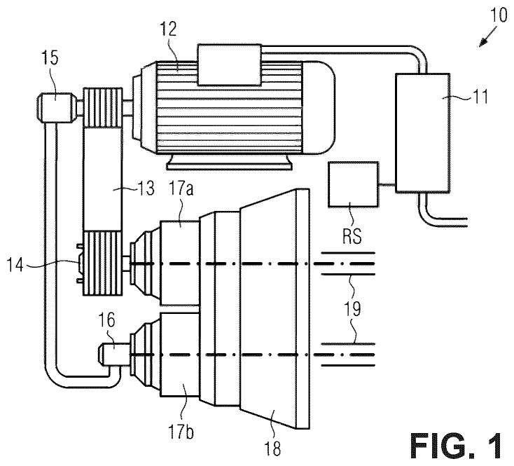

FIG. 1 illustrates an embodiment of a device according to the invention for driving a rotor shaft of a comminuting device with a motor for driving the rotor shaft via a reduction gearing and a synchronous gearing and for driving a hydraulic pump of a hydraulic gearing.

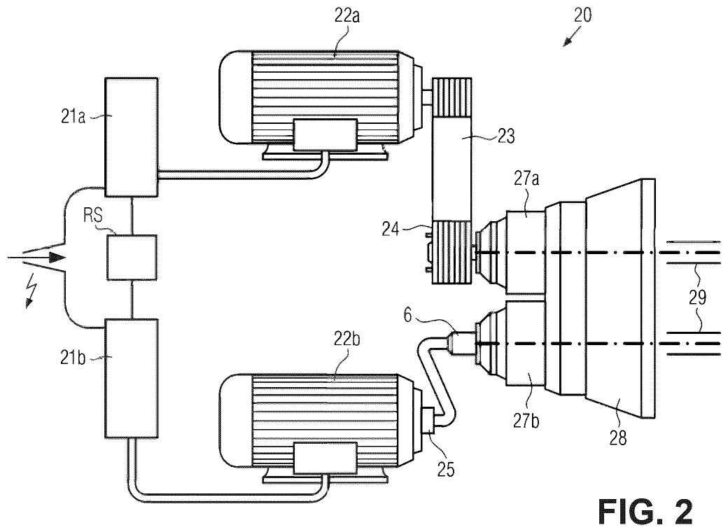

FIG. 2 illustrates a further embodiment of a device according to the invention for driving a rotor shaft of a comminuting device with a motor for driving the rotor shaft via a reduction gearing and a synchronous gearing and with a further motor for driving a hydraulic pump of a hydraulic gearing.

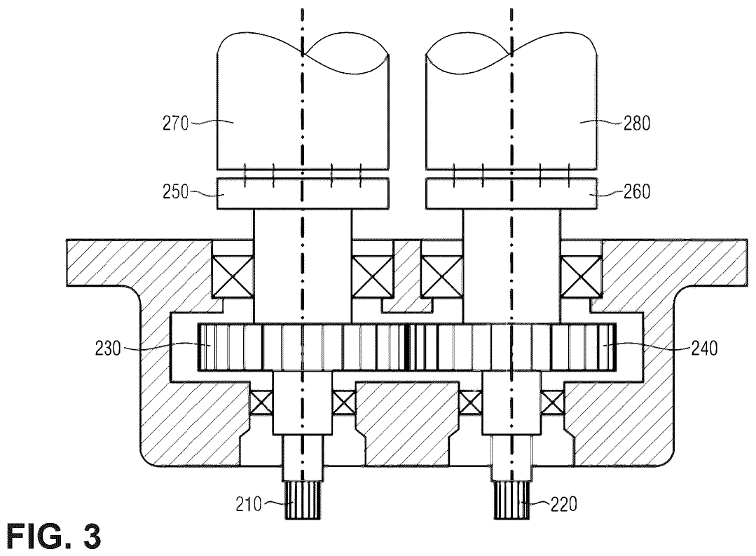

FIG. 3 shows a synchronous gearing that can be used in a device for driving a rotor shaft of a comminuting device according to an embodiment.

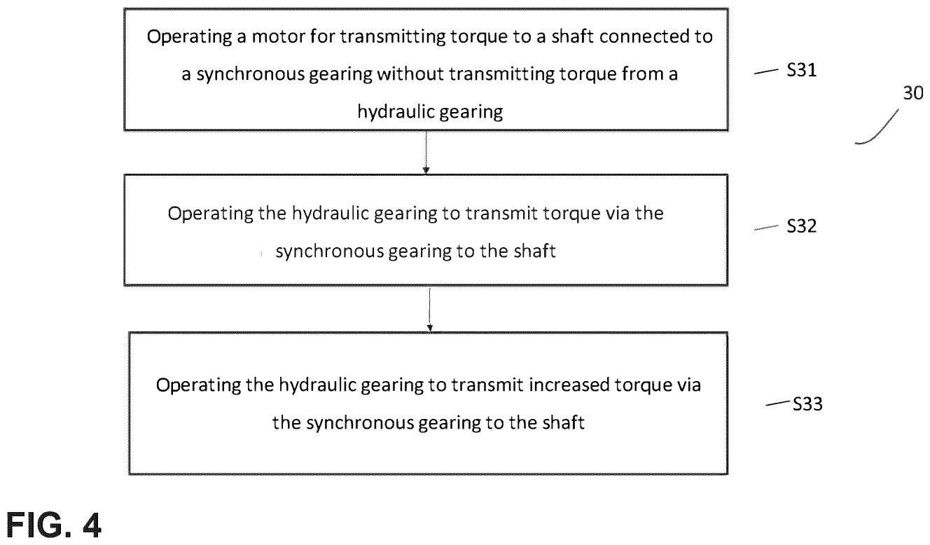

FIG. 4 shows an embodiment of a method according to the invention for operating a device for driving a rotor shaft of a comminuting device.

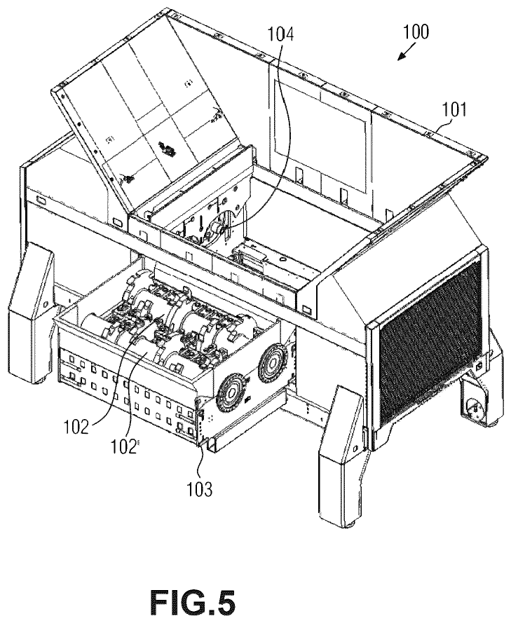

FIG. 5 shows a comminuting device in which the device according to the invention can be used.

The present invention provides a device with a power splitting for driving a rotor shaft of a comminuting device via a synchronous gearing. The device requires only relatively simply constructed components and enables energy-efficient continuous operation of a comminuting device equipped with the device with a relatively high throughput and thus relatively low costs per unit of time. The power splitting is achieved with standard components that can be flexibly combined for small machine series without the need for expensive special mechanical components such as a power-split gearing.

One embodiment of a device 10 according to the invention for driving a rotor shaft of a comminuting device is illustrated in FIG. 1. The device 10 comprises an electric motor 12 controlled/regulated by a frequency converter 11 (or alternatively an otherwise controlled/regulated combustion engine). The electric motor 12, which operates at, for example, 1200 to 1800 revolutions per minute and can have a power input of 75 to 650 kW, is connected to a first reduction gearing 17a via a direct drive 13, for example a belt drive, and a coupling 14. The coupling 14 can be configured as an overload coupling, which serves as a safety device, particularly in the event of a sudden total blockage of a rotor shaft of a comminuting device comprising the device 10 due to extraneous matter. Alternatively, the electric motor 12 can be mounted directly on the reduction gearing 17a, or it can be connected to the reduction gearing 17a via a joint shaft. Furthermore, the electric motor 12 is connected to a hydraulic pump 15 of a hydraulic gearing, which feeds a hydraulic motor 16 of the hydraulic gearing. A change in the torque requirement can be responded to by changing the hydraulic pressure of the hydraulic fluid supplied by the hydraulic pump 15. The speed of the hydraulic motor 16 can be regulated/controlled via the volume of the hydraulic fluid supplied by the hydraulic pump 15 or the displacement of the hydraulic motor 16.

The hydraulic motor 16 is connected to a second reduction gearing 17b. In accordance with the (overload) coupling 14, the hydraulic gearing can be equipped with an overpressure protection device (for example, a pressure relief valve).

The reduction gearings 17a and 17b can be formed in a single unit. The reduction gearings 17a and 17b can be configured as planetary gearings. The electric motor 12, the direct drive 13, the coupling 14 and the reduction gearing 17a represent a first power branch of the device 10. The hydraulic gearing with the hydraulic pump 15 and the hydraulic motor 16 and the reduction gearing 17b represent a second power branch of the device 10.

The reduction gearings 17a and 17b are connected to a synchronous gearing (synchronized gearing) 18, which is configured to drive one or more shafts 19, approx. one or more rotor shafts (comminuting shafts) or one or more drive shafts, which are each connected to a rotor shaft via a shaft coupling.

Via this synchronous gearing 18, the torques provided by the electric motor 11 and the hydraulic gearing, which are input via the reduction gearings 17a and 17b, are transmitted to one or more shafts 19.

All regulation/control parameters of the device 10 can be regulated/controlled via a regulation/control unit RS. The control unit RS can thus regulate/control the electric motor 12, which may be configured as an asynchronous or synchronous motor, and the frequency converter 1, which can be used to regulate/control the speed and rotation direction of the electric motor 12. The regulation/control unit RS can regulate/control the coupling 14, which can provide overload protection and/or switch the direct drive 13 on and off in a regulated manner.

The regulation/control unit RS can regulate/control the hydraulic pump 15, which can be set between 0 delivery volume and a maximum delivery volume in both directions of rotation. The regulation/control unit RS can regulate/control the hydraulic motor 16, which can be speed- and torque-regulated/controlled via oil pressure parameters and the displacement (pivot angle). The regulation/control unit RS can set the reduction gearings 17a and 17b to the required shaft speeds.

Due to the frictional connection in the synchronous gearing 18, the torque required by the rotor shaft (or shafts) can be provided to a certain extent (in the lower and middle load range) with maximum efficiency in direct drive, and the hydraulic gearing with the additional torque can only be switched in when load peaks occur. To increase the maximum shaft torque, the displacement of the hydraulic motor 16 can be regulated/controlled to a maximum, which reduces the speed to a minimum. To ensure that the power branch of the electric motor/drive can also be used when the speed is reduced, the electric motor 12 can be regulated to the speed of the hydraulic motor 16 via the frequency converter 11.

In particular, the regulation/control unit RS can regulate/control the regulation/control of the various components depending on the load. The occurring load can be determined via measured torques, current values or hydraulic pressure values, as well as a combination thereof. The regulation/control unit RS can be used to pursue different machine operation targets. The regulation can be controlled/regulated for various needs of the machine operators, for example, toward maximum energy efficiency, maximum power, or maximum throughput.

An automatic torque control/regulation and speed control/regulation of the motor may be provided. In this case, for example, the feed material, feed quantity, discharge quantity, etc. can be taken into account. For example, the comminuting device equipped with the device 10 can be operated efficiently at a relatively low speed (<rated speed) of the shaft 19 when the feed volume is low and continuous discharge is to be achieved, because, for example, a downstream unit, such as a screening plant, can then be operated more efficiently.

If the motor 12 is configured as a combustion engine, for example as a diesel engine, the direct drive must be deactivated by means of the switchable coupling 14 if the rotor shaft needs to be reversed. The maximum torque in reverse mode is thus determined by the maximum torque that can be achieved by the hydraulic gearing.

Another embodiment of a device 20 according to the invention for driving a rotor shaft of a comminuting device is illustrated in FIG. 2. In contrast to the embodiment shown in FIG. 1, the embodiment shown in FIG. 2 has two motors 22a and 22b (for example electric motors), of which the first motor 22a is connected via a direct drive 22 and a coupling 23 to a reduction gearing 27a, and the second motor 22b drives a hydraulic pump 25 of a hydraulic gearing, which feeds a hydraulic motor 26 of the hydraulic gearing. The first (electric) motor 22a is controlled/regulated by means of a frequency converter 11a, and the second (electric) motor 22b is controlled/regulated by means of a further frequency converter 11b. If combustion engines are used instead of electric motors, they are regulated/controlled in another way. Furthermore, the device 20 also has a regulation/control unit RS corresponding to the regulation/control unit RS shown in FIG. 1 (which can of course also regulate/control the further frequency converter 11b or second motor 22b).

The reduction gearings 27a and 27b can be formed in a single unit. The reduction gearings 27a and 27b can be configured as planetary gearings. The reduction gearings 27a and 27b are connected to a synchronous gearing 28 which is configured to drive one or more shafts 29, approx. one or more rotor shafts or one or more drive shafts, which are each connected to a rotor shaft via a shaft coupling. The torques provided by the first motor 22a and the hydraulic gearing, which are input via the reduction gearings 27a and 27b, are transmitted to the one or more shafts 29 via this synchronous gearing 28.

The second motor 22b for operating the hydraulic pump 25 of the hydraulic gearing does not necessarily have to be a speed-controlled motor. Speed control and direction reversal can also be achieved by means of a controlled hydraulic pump.

More than one shaft can be driven via the synchronous gearings 18 or 28 of the device 10 or 20. When used in a comminuting device with a pair of rotor shafts, switchable toothing in the synchronous gearing 18 or 28 (a displacement of a gearwheel out of tooth engagement) can be used to switch between synchronous and asynchronous operation of the (comminuting) shafts 19 or 29. In synchronous operation, the maximum total torque is distributed as required to the (comminuting) shafts 19 and 29. In asynchronous operation, one (comminuting) shaft 19 or 29 is supplied with the available torque directly via the motor 12 or 22 and the direct drive 13 or 23, and the second (comminuting) shaft 19 or 29 is supplied via the hydraulic gearing.

According to alternative embodiments, the first reduction gearing 17a, 27a in device 10 and/or the second reduction gearing 17b, 27b can be omitted if the first motor 12, 22a or the hydraulic motor 16, 26 of the hydraulic gearing provides the appropriate speed for driving the shaft(s).

FIG. 3 shows a synchronous gearing that can be used in a device for driving a rotor shaft of a comminuting device according to an embodiment. For example, the synchronous gearing 18 of the device 10 shown in FIG. 1 or the synchronous gearing 28 of the device 20 shown in FIG. 2 may be the synchronous gearing shown in FIG. 3.

On the drive side (lower side in FIG. 3), the synchronous gearing comprises two connection points (210, 220), one for the direct drive/motor and the other for the hydraulic gearing (see FIGS. 1 and 2). Reduction gearings can be interposed directly at the connection points (210, 220) (see FIGS. 1 and 2), which may be required for speed reduction as described above. To combine the drives/torques, a synchronous stage is required, as exemplarily shown in FIG. 3, as a spur gearing with gearwheels (230, 240). The diameters of the gearwheels (230, 240) do not necessarily have to be the same. Of course, any other gear stage that combines the two power branches can be used as an alternative.

Furthermore, the synchronous gearing shown in FIG. 3 has connection flanges 250 and 260 for connecting the shafts 270 and 280 to be driven. The synchronous stage can now be duplicated as required in order to drive any number of shafts simultaneously. If only one shaft 270 is to be driven, for example, the connection flange 260 is omitted. FIG. 3 shows an exemplary configuration of the synchronous gearing for driving exactly two shafts 270 and 280, which operate synchronously at the same speed with the aid of the synchronous gearing.

FIG. 4 illustrates a method 30 for operating a device for driving a rotor shaft of a comminuting device according to an embodiment of the invention. The device comprises a first motor, a hydraulic gearing with a hydraulic pump and a hydraulic motor, optionally a first reduction gearing which is different from the hydraulic gearing, optionally a second reduction gearing different from the first reduction gearing and the hydraulic gearing, and a synchronous gearing different from the hydraulic gearing and the first and second reduction gearings and configured to drive at least one rotor shaft or at least one drive shaft connected to a rotor shaft. The first motor is connected (if necessary via the first reduction gearing) to the synchronous gearing, and the hydraulic gearing is connected (if necessary via the second reduction gearing) to the synchronous gearing. The device may be, for example, the device 10 shown in FIG. 1 or the device 20 shown in FIG. 2. The hydraulic pump of the hydraulic gearing is driven either by the first motor (see the embodiment of device 10 shown in FIG. 1) or by an additional second motor (see the embodiment of device 20 shown in FIG. 2).

Initially, in a first operating state, the first motor of the device is operated in order to transmit a torque via the first reduction gearing (if present) and the synchronous gearing to at least one shaft connected to the synchronous gearing (rotor shaft or drive shaft for a rotor shaft) S31 when a relatively small or medium load is applied to this at least one shaft. In this first operating state, no significant additional torque is transmitted to the at least one shaft connected to the synchronous gearing via the hydraulic gearing. For example, the hydraulic gearing is decoupled in this operating state or the hydraulic pump of the hydraulic gearing does not deliver.

When the load on the at least one drive or rotor shaft increases, i.e. when the torque requirement increases, and when a predetermined first load threshold is exceeded, torque is additionally transmitted from the hydraulic gearing to the at least one drive or rotor shaft via the second reduction gearing (if present) and the synchronous gearing in a second operating state S32. For this purpose, the hydraulic pump supplies a hydraulic/pressure fluid (hydraulic oil) to the hydraulic motor, which operates in this second operating state with a relatively small displacement and hydraulic pressure.

If the load on the at least one drive or rotor shaft continues to increase, i.e. if the torque requirement increases, when a predetermined second load threshold is exceeded in a third operating state, the hydraulic gearing provides a torque that is higher than in the second operating state S33, i.e. the hydraulic pressure from the hydraulic pump is further increased and the hydraulic motor operates in this third operating state with a relatively large displacement that is increased compared to the second operating state. The torque transmitted to the drive or rotor shaft via the synchronous gearing is thereby further increased compared to the second operating state. The hydraulic pressure can be increased up to a given maximum value at which the maximum torque is reached at the maximum speed of the at least one drive or rotor shaft. This maximum torque with the maximum speed of the at least one drive or rotor shaft can be further increased by reducing the speed of the at least one drive or rotor shaft if, when the maximum hydraulic pressure and maximum delivery volume of the hydraulic pump are reached, the displacement of the hydraulic motor can be further increased (at maximum displacement of the hydraulic motor, the latter provides the minimum speed). When the speed of the drive or rotor shaft is reduced, it is necessary to regulate/control the first motor to the speed of the hydraulic motor in order to continue using it for torque transmission.

The device according to the invention for driving a rotor shaft of a comminuting device, for example the device 10 shown in FIG. 1 or the device 20 shown in FIG. 2, is suitable for use in a comminuting device for comminuting wood, plastic or textile waste products or other industrial, agricultural and household waste. Such a comminuting device can weigh between 10 and 20 tons, for example, and absorb a drive power of 75 to 650 kW and have one or more rotor shafts which are operated at, for example, 20 to 40 revolutions per minute.

An exemplary embodiment of a comminuting device 100 in the form of a two-shaft comminutor is shown in a maintenance state in FIG. 5. The comminuting device 100 shown in FIG. 5 comprises a shaft coupling device 10. The comminuting device 100 comprises a material receiving space 101 into which material to be comminuted can be fed. For example, the material receiving space 101 can be fed with the material to be comminuted by wheel loaders, forklifts or conveyor belts via a hopper.

The material to be comminuted is comminuted by means of rotor shafts 102, 102′, which are equipped with knives. A presser not shown in FIG. 5 may be provided to press the material to be comminuted onto the rotor shafts 102, 102′. In the maintenance state, the rotor shafts 102, 102′ are moved out of the material receiving space 101 laterally on a carrier cassette 103. The comminuting device 100 comprises, for each of the two rotor shafts 102, 102′, a drive shaft, the shaft hubs 104 of which can be positioned inside or outside the material receiving space 101.

Furthermore, the comminuting device 100 comprises a device for driving a rotor shaft of a comminuting device. The device comprises a first motor, a hydraulic gearing with a hydraulic pump and a hydraulic motor, optionally a first reduction gearing which is different from the hydraulic gearing, optionally a second reduction gearing different from the first reduction gearing (if present) and the hydraulic gearing, and a synchronous gearing different from the hydraulic gearing and the first and second reduction gearings (if present) and configured to drive at least one rotor shaft or at least one drive shaft connected to a rotor shaft. The synchronous gearing is connected to the two drive shafts 102, 102′ associated with the rotor shafts for driving the same.

The first motor is connected (if necessary via the first reduction gearing) to the synchronous gearing, and the hydraulic gearing is connected (if necessary via the second reduction gearing) to the synchronous gearing. For example, the device for driving a rotor shaft of a comminuting device comprised by the comminuting device 100 is the device 10 shown in FIG. 1 or the device 20 shown in FIG. 2.

1. A device for driving a rotor shaft of a comminuting device, comprising:
a first motor;
a hydraulic gearing; and
a synchronous gearing which is different from the hydraulic gearing and is configured to drive at least one rotor shaft or at least one drive shaft connected to a rotor shaft; and
wherein the first motor and the hydraulic gearing are connected to the synchronous gearing.

2. The device according to claim 1, further comprising:
a first reduction gearing which is different from the hydraulic gearing; and/or
a second reduction gearing which is different from the first reduction gearing and the hydraulic gearing; and
wherein at least one selected from the group consisting of (1) the first motor is connected to the first reduction gearing; (2) the hydraulic gearing is connected to the second reduction gearing; and (3) at least one selected from the group consisting of the first and the second reduction gearing is connected to the synchronous gearing.

3. The device according to claim 1 further comprising at least one selected from the group consisting of a direct drive and a coupling via which the first motor is connected to the synchronous gearing.

4. The device according to claim 1, wherein the first motor is a first electric motor.

5. The device according to claim 4, further comprising a first frequency converter configured to regulate or control at least one selected from the group consisting of the speed and direction of rotation of the first electric motor.

6. The device according to claim 1, wherein the first motor is connected to the hydraulic gearing.

7. The device according to claim 6, wherein the hydraulic gearing comprises a hydraulic pump operable by the first motor and a hydraulic motor connected to the hydraulic pump.

8. The device according to claim 1, further comprising a second motor different from the first motor and connected to the hydraulic gearing.

9. The device according to claim 8, wherein the hydraulic gearing comprises a hydraulic pump operable by the second motor and a hydraulic motor connected to the hydraulic pump.

10. The device according to claim 8, wherein the second motor is a second electric motor.

11. The device according to claim 10, further comprising a second frequency converter configured to regulate or control the speed and/or the direction of rotation of the second electric motor.

12. A comminuting device comprising:
a material receiving space;
a rotor shaft arranged in the material receiving space; and
a device for driving the rotor shaft, comprising:
a first motor;
a hydraulic gearing; and
a synchronous gearing which is different from the hydraulic gearing and is configured to drive at least one rotor shaft or at least one drive shaft connected to a rotor shaft; and
wherein the first motor and the hydraulic gearing are connected to the synchronous gearing.

13. The comminuting device according to claim 12, wherein the comminuting device is a single-shaft, multi-shaft comminutor, or a vertical comminutor.

14. A method for operating a device, comprising the following steps carried out in succession in the order listed:
providing a device for driving the rotor shaft, comprising:
a first motor;
a hydraulic gearing; and
a synchronous gearing which is different from the hydraulic gearing and is configured to drive at least one rotor shaft or at least one drive shaft connected to a rotor shaft; and
wherein the first motor and the hydraulic gearing are connected to the synchronous gearing
operating the first motor to transmit torque via the synchronous gearing (18, 28) to at least one shaft connected to the synchronous gearing in a first operating state at a first load of the at least one shaft essentially without transmitting torque from the hydraulic gearing to the at least one shaft;
additionally operating the hydraulic gearing for transmitting torque via the synchronous gearing to the at least one shaft in a second operating state at a second load of the at least one shaft which is greater than the first load; and
operating the hydraulic gearing for transmitting a torque increased relative to the second operating state via the synchronous gearing to the at least one shaft in a third operating state at a third load of the at least one shaft which is greater than the second load.

15. The method according to claim 14, further comprising operating the hydraulic gearing in a fourth operating state following the third operating state with an increased displacement of a hydraulic motor of the hydraulic gearing relative to the third operating state and adjusting the speed of the first motor to the speed of the hydraulic motor of the hydraulic gearing.

16. The device according to claim 2 further comprising at least one selected from the group consisting of a direct drive and a coupling via which the first motor is connected to the synchronous gearing.

17. The device according to claim 2, wherein the first motor is a first electric motor.

18. The device according to claim 3, wherein the first motor is a first electric motor

19. The device according to claim 2, wherein the first motor is connected to the hydraulic gearing.

20. The device according to claim 3, wherein the first motor is connected to the hydraulic gearing.
